(19) United States
(12) Patent Application Publication
(10) Pub. No.: US 2009/0179775 A1
(43) Pub. Date: Jul. 16, 2009

(54) SECURE INFORMATION SYSTEM

(75) Inventor: JEREMY BOS, GRAND HAVEN, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/972,499

(22) Filed: Jan. 10, 2008

(51) Int. Cl. G08G 1/09

(52) U.S. Cl. 340/905

(57) ABSTRACT

Methods and apparatus are provided for a secure inter-vehicle information system. The apparatus comprises a satellite adapted to broadcast a satellite radio signal comprising security information and satellite radio information, a satellite radio receiver adapted to receive the satellite radio signal and adapted to separate the security information from the signal, a computer system adapted to receive the security information and generate status information, and a transceiver adapted to receive status information from the computer system and transmit the status information.

### TECHNICAL FIELD

The subject matter described herein generally relates to authentication of sources in a secure information exchange system, and more particularly relates to updating trusted sources of information in a vehicular information system.

### BACKGROUND

A vehicle traveling in proximity to other vehicles can encounter circumstances which present dangers to both it and neighboring vehicles. In one example, a vehicle may encounter a hazard which requires sudden braking. Although an immediately-following vehicle may be able to see the braking indicators, other vehicles may not. Because of the chain reaction inherent in such situations, it would be advantageous to communicate braking information to nearby vehicles. In another example, as two vehicles travel single-file on a road, they may encounter another slower-moving vehicle. While the lead vehicle may identify the slower vehicle for passing and do so, the trailing vehicle would have no notice of the slower-moving vehicle until the lead vehicle had begun the passing maneuver, and would be forced to brake suddenly, if passing were not an option.

Other examples where inter-vehicle communication may be beneficial exist as well. However, to provide reliable safety information in the exchange between vehicles, each vehicle must verify that the received information is being broadcast by a trusted source. Accordingly, not only should the information be encrypted, but the broadcast source must be authenticated as well.

For various reasons, such as tampering, vehicle theft, or obsolete methodologies, some valid and authenticatable sources may become untrusted and invalid sources of information. Such an occurrence would generate an authentication revocation entry, which must be distributed to all vehicles, that they may remove the subject vehicle from the list of trusted sources of information. Due to the distributed nature of vehicles, transmitting authentication revocation entries can be difficult.

### BRIEF SUMMARY

A system is provided for secure information transfer. The apparatus comprises a satellite adapted to broadcast a satellite radio signal comprising security information and satellite radio information, a satellite radio receiver adapted to receive the satellite radio signal and adapted to separate the security information from the signal, a computer system adapted to receive the security information and generate status information, and a transceiver adapted to receive status information from the computer system and transmit the status information.

A method is provided for adjusting the authorization list of a DSRC-equipped vehicle comprising a computer system. The method comprises receiving a signal from an Earth-orbiting artificial satellite with a satellite radio receiver, the signal comprising security information and satellite radio content, separating the security information from the signal, and providing the security information to the computer system.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

At least one embodiment of the present invention will hereinafter be described in conjunction with the following drawing figures, wherein like numerals denote like elements, and

FIG. 1 depicts an embodiment of a vehicle with a secure information system;

FIG. 2 illustrates an embodiment of a secure information distribution system; and

FIG. 3 is a schematic illustration of the steps of a process of an operation in a secure information distribution system.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a satellite system or a component thereof may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of data transmission protocols and that the system described herein is merely one suitable example.

For the sake of brevity and clarity, conventional techniques related to data transmission, signaling, network control, and other functional aspects of the systems (and the individual operating components of the systems) may not be described in detail herein. Furthermore, the lines or waves shown in the various figures contained herein are intended to represent example functional relationships and/or physical couplings between the various elements. It should be noted that many alternative or additional functional relationships or physical connections may be present in an embodiment of the subject matter.

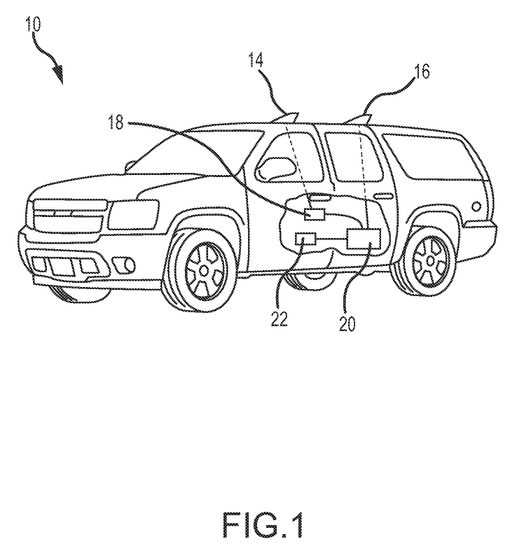

“Connected/Coupled”—The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one example arrangement of elements, additional intervening elements, devices, features, or components may be present in an embodiment of the depicted subject matter.

The various tasks performed in connection with methods described herein may be performed by software, hardware, firmware, or any combination thereof, or combinations with additional components.

FIG. 1 illustrates a vehicle 10 comprising a secure inter-vehicle information system. The vehicle 10 can be any type of vehicle, such as a car, truck, SUV, tractor truck, motorcycle, or emergency vehicle. The vehicle 10 can also be an off-road vehicle or any other suitable platform.

The vehicle 10 can comprise a computer system 20. The computer system 20 can be of any suitable type, with varying features such as the number or type of components, speed of processing, size of available storage space, or other features. The computer system 20 can be coupled with the vehicle 10 in any of several locations, including without limitation, within the frame, in a separate compartment either inside or outside the passenger cabin, in the storage area of the vehicle 10, or any other suitable location.

The vehicle 10 can have various communications antennas 14, 16. In the illustrated embodiment, two antennas 14, 16 are shown, but more or other types can also be present. The vehicle 10 can have a satellite radio antenna 14 and a Dedicated Short-Range Communications (DRSC) 16 antenna. Other antenna types, such as cellular, CB-band, or satellite phone can also be present.

The satellite radio antenna 14 can be configured to receive signals at frequencies corresponding to commercial satellite radio services. The satellite radio antenna 14 can be coupled to a satellite radio receiver 18 or satellite radio player. The player can be a device or portion of the satellite radio receiver 18 configured to produce music and other audio entertainment from the satellite radio services. Although shown as separate entities in FIG. 1, the satellite radio antenna 14 can be integrated with the satellite radio receiver 18 as a single component. In some embodiments, the satellite radio antenna 14 can be integrated with other antennas, such as AM/FM band radio antennas, DSRC antennas, satellite phone antennas, or the like. In some embodiments, the satellite radio antenna 14 can be contained within the satellite radio receiver 18, or formed integrally with the satellite radio receiver 18, such as by forming at least a portion of the housing.

The satellite radio receiver 18 can be configured to exchange information with the computer system 20. In some embodiments, information can be provided in only one direction, either from the satellite radio receiver 18 to the computer system, or the reverse. In some embodiments, information can be provided by either component to the other. In some embodiments, the computer system 20 can be coupled to either or both of the antennas 14, 16, when formed as integral units and receive information from or provide information to either or both portions of the antennas 14, 16.

The computer system 20 can be coupled to a control system 22 of the vehicle. The control system 22 can in turn be coupled to a plurality of sensors distributed throughout the vehicle to monitor different states of operation, including without limitation temperature sensors, pressure sensors, gyroscopic sensors, and accelerometers. The control system 22 can also couple to audio, visual, or tactile output devices. The output devices can be visible, audible, or tactilely perceptible to the operator of the vehicle or other occupants of the vehicle. Some output devices can include clear or colored lighting components, such as LEDs, incandescent lamps, LCD displays, Heads Up Displays (HUDs), piezoelectric buzzers or speakers, car stereo devices, vibration devices, though other devices are possible. The control system 22 can receive input from such sensory devices as engine coolant temperature, tachometer measurements, speedometer readings, tire pressure readings, collision detection sensors, seatbelt usage detectors, and other sources. The computer system 20 and control system 22 can be a single processing device or separate devices. In some embodiments, sensory devices can provide information directly to the computer system 20. Furthermore, in some embodiments, the computer system 20 can be integrated with the satellite radio receiver 18. In some embodiments, some functions of the computer system 20 can be performed by the satellite radio receiver 18, such as signal processing.

The DSRC Security system, as a secure inter-vehicle communication system, is well-known in the art. Through the use of the DSRC Security system, vehicles can exchange, through secure communication methods, information about themselves and nearby vehicles. To a vehicle using the DSRC Security system, nearby vehicles can be considered “remote” vehicles for purposes of determining whether vehicle information is being generated by the selfsame vehicle or arriving from another source. Through the use of DSRC, vehicles can communicate some or all of the information determined by the control system 22 to other vehicles. The computer system 20 can operate under a set of instructions through software or firmware or the like, to monitor the control system 22 for any of a set of conditions that can lead to transmission of information to other vehicles.

As a non-limiting example, sudden braking of the vehicle 10 can be detected by the control system 22 and that information can be in turn provided to the computer system 20. The computer system 20 can, as one non-limiting example of an operation, create a signal informing nearby, DSRC-participating vehicles of the action by transmitting vehicle information data. A vehicle would receive such a transmission as remote vehicle information data. The computer system 20 can interact with the control system 22 to activate a visual, audio, or tactile cue. Such a cue can convey information to an occupant of the vehicle, communicating the information received from the remote vehicle.

The DSRC antenna 16 can be a single short-range receiving antenna or can be formed as part of a short-range receiver or transceiver. A DSRC transceiver can both receive DSRC-formatted signals and transmit them. In some embodiments, the DSRC antenna 16 is a portion of the DSRC transceiver. In some embodiments, the DSRC antenna 16 is a separate device which is coupled to the DSRC transceiver. The DSRC transceiver can comprise a short-range transmitter suitable for use in the DSRC system.

The information in DSRC signals can be encrypted. Preferably, DSRC signals are encrypted with a public-key encryption method, which is well-known in the art. In some embodiments, encryption algorithms such as AES or Diffie-Hellman elliptical can be used.

As part of the DSRC system, the identity of participating vehicles can be ascertained prior to accepting a DSRC signal as valid. A valid DSRC signal can be considered to contain relevant and reliable information for use in the DSRC system. An invalid signal cannot be trusted to contain relevant and/or reliable information. Accordingly, establishing whether a DSRC signal is originating from a trusted source or an untrusted source can be accomplished prior to acting upon information exchanged from the source in the DSRC signal.

Valid signals can be those which are broadcast from a source which can be authenticated, which can be called trusted sources. A trusted source is one that can correctly authenticate its identity through the use of techniques such as public-key encryption and one that is known to be trustworthy. Invalid signals can be those which are broadcast from a source which either is unknown or known to be untrusted. An untrusted source can be either untrusted from its inception—that is, never recognized as a trusted source—or a trusted source that has become compromised for any reason. One non-limiting example of a source untrusted from its inception is a malicious source attempting to masquerade as a trusted DSRC source. A non-limiting example of a trusted source which becomes untrusted is a trusted source, such as a vehicle, which is stolen. After the trusted source leaves the control of a trusted party, it can be considered untrusted. Such untrusted sources can become trusted sources after recovery of the vehicle and inspection for tampering. Another non-limiting example of a trusted source which becomes untrusted is a vehicle whose owners attempt to alter the content of DSRC messages.

A source can be designated trusted or untrusted by a central authority. Authentication of sources as trusted sources can be accomplished through use of a certificate. A certificate can be unique to each source. Such a source-identifying certificate can be called an identification certificate. Accordingly, when a DSRC-equipped vehicle receives a DSRC signal, the signal can contain, among other things, a digital copy of the certificate. The DSRC-equipped vehicle can extract the certificate from the signal and compare the certificate against a list of certificates stored in the computer system 20. If the certificate is for a trusted source, and the public-key encryption supports that the source is the same as identified by the certificate, the DSRC-equipped vehicle can accept and treat the DSRC signal as valid. The use of public-key encryption algorithm to establish identity with certificates is well known in the art.

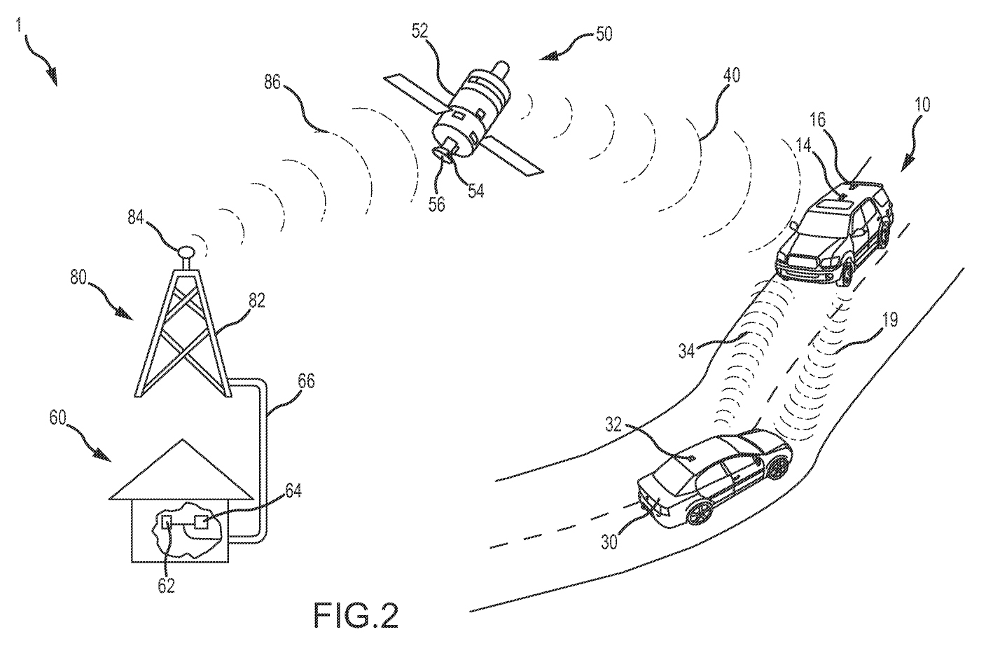

With reference to FIG. 2, the vehicle 10 is shown traveling. A nearby remote vehicle 30 is shown within DSRC transmission range. In some instances, the remote vehicle 30 may initiate a remote DSRC signal 34 from a remote DSRC antenna 32. Similarly, a locally-originating DSRC signal 19 can be emitted from the DSRC antenna 16 of the vehicle 10. The vehicle 10 can perform an authentication procedure to determine whether the remote vehicle 30 is a trusted or untrusted source.

Because vehicles are widely distributed, changes to the certificate list within each vehicle can be difficult to effect to each vehicle. It is critical, however, that untrusted sources be removed from the certificate list in each vehicle to promote safety through use of the DSRC system.

Accordingly, a certificate authority 60 can maintain a certificate server 62. The certificate server 62 can be any computer, network, or processing device capable of maintaining the certificate list. Additionally, the certificate server 62 can generate a certificate change list, which can identify certificates of vehicles which are to become trusted or untrusted sources. The certificate list and certificate change list can be considered vehicle safety information because the content of either list contributes to correct functioning of the DSRC system.

The certificate server 62 can be in communication with additional communication devices, such as a satellite radio content source 64. Either the certificate server 62 or the content source 64 can be configured to produce an uplink signal 86 which combines certificate information and satellite radio content. Additionally, the certificate server 62 and the content source 64 can independently prepare signals which can be combined into a single uplink signal 86. The length of transmission of the signals can be different or the same. As one example, a continuous signal containing satellite radio content can be prepared with only a single, short addition of certificate information to the signal. In another example, the certificate information can be repeated at definite intervals or certain times, despite continuous satellite radio content.

Through any suitable device, method, or means, such as a cable 66, the certificate server 62 and/or content source 64 can be connected to a terrestrial broadcast source 80. The terrestrial broadcast source 80 can also be a transmission source, configured to send a more focused signal. Some embodiments of the terrestrial broadcast source 80 can comprise a support structure 82 and a transmission source 84. Other terrestrial broadcast sources can have broadcast or transmission sources 84 integrally-formed with the support structure 82. The terrestrial broadcast source 80 can be located in any suitable terrain, preferably with an unimpeded view of the sky.

The terrestrial broadcast source 80 can be constructed to transmit any of several signals. In some embodiments, the terrestrial broadcast source 80 can be configured to transmit an uplink signal 86 which contains both certificate information and/or satellite radio content information. Additionally, in some embodiments, the terrestrial broadcast source 80 can be configured to receive both the satellite radio content and certificate information and combine them into a single uplink signal 86. Additionally, the terrestrial broadcast source 80 can be configured to broadcast two independent signals for both the satellite radio content information and the certificate information. In such cases, different frequencies can be used, or the information can be alternated serially.

The entire uplink signal 86, or any portion thereof, can be encrypted, through public-key encryption or another method, either before it is provided to the terrestrial broadcast source 80 or, when unencrypted information is provided, it can be encrypted at the terrestrial broadcast source 80.

The uplink signal 86 can be directed towards a communications satellite 50. The satellite 50 can be artificial and placed in orbit around the Earth. The satellite can comprise a frame 52, an uplink receiving site 54 and a broadcast site 56. The frame 52 can support at least the uplink receiving site 54 and the broadcast site 56. The frame 52 can support additional components of the satellite 50, such as solar panels, radio antennas, attitude thrusters, a guidance computer, and any other suitable component.

The uplink receiving site 54 can be configured to receive the uplink signal 86. In those embodiments where the satellite radio content information and the certificate information are transmitted as separate signals, the satellite 50 can be configured to receive both signals and combine them to a single satellite radio broadcast signal 40.

The broadcast site 56 can be any suitable transmission device adapted to broadcast the satellite radio broadcast signal 40 towards the Earth. Preferably, the broadcast site 56 can emit a satellite radio broadcast signal 40 of sufficient strength to be received at any place on the Earth within line of sight of the satellite 50. The satellite radio broadcast signal 40, or certain portions thereof, preferably is encrypted. In those embodiments where the uplink signal 86 is not encrypted, encryption can be performed by a component of the satellite 50.

The satellite radio broadcast signal 40 can be received by any satellite receiver suitably configured to do so. The satellite radio broadcast signal 40 can include the certificate information. Accordingly, when the certificate authority indicates a certificate is to become untrusted, it can issue a certificate revocation, whereby DSRC-equipped vehicles can remove the source from their certificate list. Such an issuance can be the transmission of a certificate revocation list, containing one or more certificates to be considered untrusted.

The certificate revocation list can be a part of the signal sent by the certificate server 62 through the uplink signal 86. Thus, when the satellite 50 broadcasts the satellite radio broadcast signal 40, the vehicle 10 can receive the signal 40 with its satellite antenna 14. The satellite radio receiver 18 can transfer the certificate revocation list to the computer system 20, wherein the vehicle's certificate list can be adjusted to designate certificates as untrusted, remove them from the list, or add new, trusted certificates to the list. Thus, the certificate revocation list can be provided to all vehicles with a satellite antenna 14. In some embodiments, the certificate list updates can be received and acted upon without regard to operation of the satellite radio receiver. Thus, even vehicles who have the satellite radio components can receive certificate information even if they do not subscribe to satellite radio service. In some embodiments, the certificate information is transmitted along a side channel, or at a wavelength that is not suitable for satellite radio content because of low speed of data transmission, or other technical characteristics which make it unfavorable. Whether certificate information is transmitted or not, the satellite radio content can be provided to the vehicle's operator or passengers for auditory entertainment.

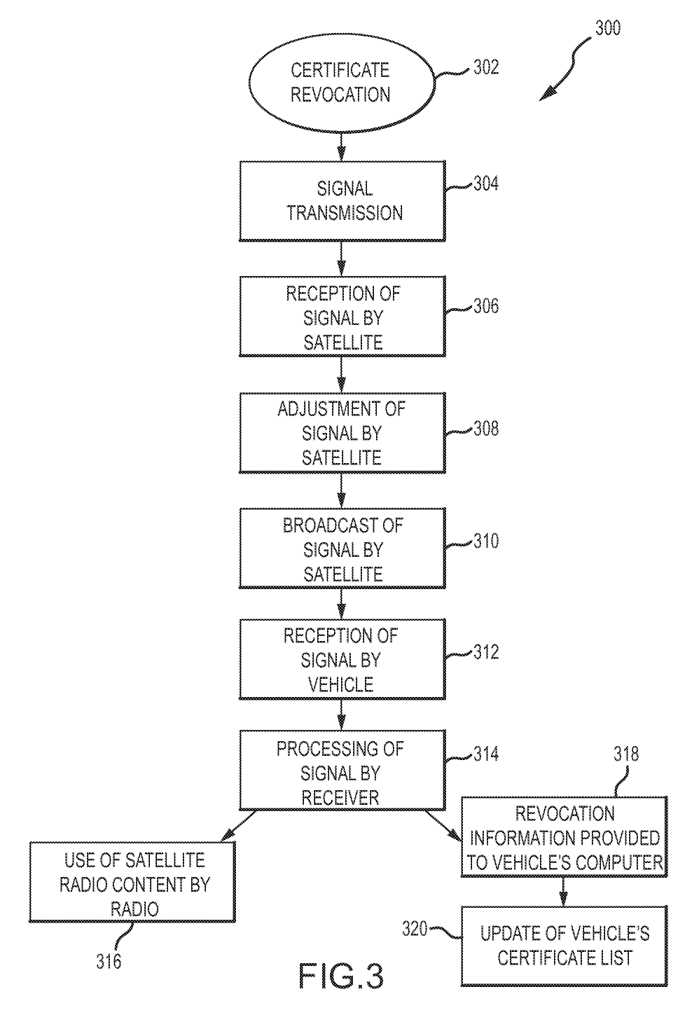

FIG. 3 illustrates a sequence 300 of steps by which the certificate list of a vehicle can be updated through satellite radio broadcast can occur. In some embodiments, certificate information changes such as the addition of certificates to a vehicle's list or revocation of some certificates can be provided to the vehicle through the above-described method. As one non-limiting example of the use of an embodiment, a certificate revocation 302 can be performed, providing a certificate revocation list to at least one vehicle. In some embodiments, a certificate authority can transmit a signal 304 from a terrestrial transmission source. As previously described, the certificate revocation list can be encrypted and/or combined with satellite radio content in any of a number of combinations. The terrestrial transmission source can provide the certificate update list to an Earth-orbiting satellite, which receives 306 the signal. In some embodiments, the satellite can adjust 308 the signal and/or the certificate revocation list, as described above, either by combining it with the satellite radio content or encrypting the signal, or adjusting the frequency, or any other suitable signal processing technique. In some embodiments, no signal adjustment is performed. After adjustment, or if no adjustment is necessary, a signal comprising at least the certificate revocation list can be broadcast 310 towards the earth. Preferably, the signal additionally comprises satellite radio content information. The signal can be received 312 by any antenna configured to receive and/or decrypt the signal. A vehicular satellite receiver can be adapted to comprise such an antenna. The vehicular satellite receiver can process 314 the incoming signal and separate satellite radio content information from the certificate revocation list. The vehicular satellite receiver can then use 316 the satellite radio content information to provide auditory entertainment to occupants of the vehicle. The vehicular satellite receiver can also provide 318 the certificate revocation list to the vehicle's computer system. The computer system can then update 320 its certificate list, removing the revoked certificates as possible sources of valid vehicle information in the DSRC system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A secure inter-vehicle information system comprising:
a terrestrial transmission source adapted to provide satellite radio content information and security information to at least one Earth-orbiting satellite;
at least one satellite adapted to orbit the Earth and broadcast a satellite radio signal, the signal comprising content derived from the satellite radio content information and the security information; and
a vehicle having:
a satellite receiver adapted to receive the signal from at least one satellite radio service and separate the content information and the security information; and
a computer system adapted to store authentication information, the computer system configured to receive the security information from the satellite receiver and adjust the authentication information in response to the security information.

2. The information system of claim 1, wherein the vehicle further comprises a satellite radio player adapted to audibly present the content information.

3. The information system of claim 1, wherein the security information comprises an authentication revocation list.

4. The information system of claim 3, wherein the vehicle further comprises a short-range receiver adapted to receive vehicle information data from at least one remote vehicle and provide the vehicle information data to the computer system.

5. The information system of claim 4, wherein the computer system is adapted to authenticate that the at least one remote vehicle participates in a Dedicated Short-Range Communications (DSRC) system.

6. The information system of claim 5, wherein the computer system is adapted to disregard vehicle information data from untrusted remote vehicles.

7. The information system of claim 1, wherein the computer system is configured to provide information to an occupant of the vehicle in response to the vehicle information data.

8. The information system of claim 1, wherein the vehicle further comprises a short-range transmitter adapted to broadcast vehicle information data provided by the computer system.

9. The information system of claim 3, wherein the vehicle information data is encrypted.

10. The information system of claim 9, wherein the vehicle information data is encrypted with a public-key encryption algorithm.

11. A method of adjusting the authorization list of a DSRC-equipped vehicle comprising a computer system, the method comprising:
receiving a signal from an Earth-orbiting artificial satellite with a satellite radio receiver, the signal comprising security information and satellite radio content;
separating the security information from the signal; and
providing the security information to the computer system.

12. The method of claim 11, wherein the security information comprises an authentication revocation list.

13. The method of claim 12, further comprising revoking certificates from the authentication revocation list from a list of valid DSRC sources stored in the computer system.

14. The method of claim 11, further comprising providing the satellite radio content to a satellite radio device adapted to present the additional information as auditory entertainment.

15. A secure information transmission system comprising:
a satellite adapted to broadcast a satellite radio signal comprising:
security information; and
satellite radio information;
a satellite radio receiver adapted to receive the satellite radio signal and adapted to separate the security information from the signal;
a computer system adapted to receive the security information and generate status information; and
a transceiver adapted to receive status information from the computer system and transmit the status information.

16. The secure information transmission system of claim 15, wherein the status information comprises an identification certificate.

17. The secure information transmission system of claim 15, wherein the computer system is adapted to monitor at least one state of operation of a vehicle.

18. The secure information transmission system of claim 15, wherein the transceiver is adapted to receive remote information from at least one remote transceiver.

19. The secure information transmission system of claim 18, wherein the at least one remote transceiver is disposed in a vehicle.

20. The secure information transmission system of claim 19, wherein the computer system is configured to determine the state of trust of the at least one remote transceiver based at least in part on the security information.
